(19) United States
(12) Patent Application Publication
(10) Pub. No.: US 2025/0092183 A1
(43) Pub. Date: Mar. 20, 2025

(54) PREPOLYMER COMPOSITION, POLYURETHANE RESIN, ELASTIC MOLDED ARTICLE, AND METHOD OF PRODUCING PREPOLYMER COMPOSITION

(71) Applicant: MITSUI CHEMICALS, INC., Tokyo (JP)

(72) Inventor: Kazuhiro MAEKAWA, Sodegaura-shi, CHIBA (JP)

(21) Appl. No.: 18/724,079

(22) PCT Filed: Feb. 7, 2023
(86) PCT No.: PCT/JP2023/003984

§ 371 Date: Jun. 25, 2024

(30) Foreign Application Priority Data
Feb. 9, 2022 (JP) 2022-018381

(51) Int. Cl. C08G 18/12; C08G 18/28; C08G 18/32

(52) U.S. Cl. CPC C08G 18/12; C08G 18/2805; C08G 18/3206

(57) ABSTRACT

A prepolymer composition containing an isocyanate group-terminated prepolymer is provided. The isocyanate group-terminated prepolymer contains a reaction product of a polyisocyanate component including 1,4-bis(isocyanatomethyl) cyclohexane and a polyol component including a first macrodiol and a second macrodiol. The first macrodiol has a hydroxyl group value of more than 56.1 mgKOH/g and less than 172 mgKOH/g. The second macrodiol has a hydroxyl group value of 374 mgKOH/g or more and 561 mgKOH/g or less. The ratio of the second macrodiol with respect to the total mol of the first macrodiol and the second macrodiol is 30 to 55 mol %.

### TECHNICAL FIELD

The present invention relates to a prepolymer composition, a polyurethane resin, an elastic molded article, and a method of producing the prepolymer composition.

### BACKGROUND ART

A polyurethane resin has, for example, a soft segment formed by the reaction of a polyisocyanate with a macropolyol and a hard segment formed by the reaction of a polyisocyanate with a chain extender.

More specifically, a polyurethane resin produced by the following method has been known. That is to say, first, 64.8 parts by mass of 1,4-bis(isocyanatomethyl) cyclohexane is reacted with 25 parts by mass of a polyester polyol having a number average molecular weight of 500 and 75 parts by mass of a polyester polyol having a number average molecular weight of 1000 to produce an isocyanate group-terminated prepolymer having a content ratio of the isocyanate group of 10.63% by mass. Next, the isocyanate group-terminated prepolymer is reacted with a 1, 4-butanediol to produce a polyurethane resin (for example, see Patent Document 1 (Synthesis Example 3 and Example 3)).

### CITATION LIST

### Patent Document

Patent Document 1: PCT International Publication No. 2019/069802

### SUMMARY OF THE INVENTION

### Problem to be Solved by the Invention

The above-described polyurethane resin has excellent mechanical properties. On the other hand, when the above-described polyurethane resin is cast molded, a contraction thereof may cause an internal defect.

The present invention includes a prepolymer composition for producing a polyurethane resin having excellent mechanical properties (high hardness) and suppressing an internal defect, a polyurethane resin and an elastic molded article that are produced from the prepolymer composition, and a method of producing the prepolymer composition.

### Means for Solving the Problem

The present invention [1] includes a prepolymer composition including: an isocyanate group-terminated prepolymer, wherein the isocyanate group-terminated prepolymer contains a reaction product of a polyisocyanate component including 1,4-bis(isocyanatomethyl) cyclohexane and a polyol component including a first macrodiol (A) and a second macrodiol (B), wherein the first macrodiol (A) has a hydroxyl group value of more than 56.1 mgKOH/g and less than 172 mgKOH/g, wherein the second macrodiol (B) has a hydroxyl group value of 374 mgKOH/g or more and 561 mgKOH/g or less, and wherein a ratio of the second macrodiol (B) with respect to a total mol of the first macrodiol (A) and the second macrodiol (B) is 30 mol % or more and 55 mol % or less.

The present invention [2] includes the prepolymer composition described in the above-described [1], wherein the ratio of the second macrodiol (B) with respect to a total mol of the polyisocyanate component, the first macrodiol (A), and the second macrodiol (B) is 8 mol % or more and 15 mol % or less.

The present invention [3] includes the prepolymer composition described in the above-described [1] or [2], further including acetylacetone.

The present invention [4] includes a polyurethane resin, including: a reaction product of a prepolymer composition containing an isocyanate group-terminated prepolymer and a chain extending component containing a chain extender (C), wherein the isocyanate group-terminated prepolymer contains a reaction product of a polyisocyanate component including 1,4-bis(isocyanatomethyl) cyclohexane and a polyol component including a first macrodiol (A) and a second macrodiol (B), wherein the first macrodiol (A) has a hydroxyl group value of more than 56.1 mgKOH/g and less than 172 mgKOH/g, wherein the second macrodiol (B) has a hydroxyl group value of 374 mgKOH/g or more and 561 mgKOH/g or less, and wherein a ratio of the second macrodiol (B) with respect to a total mol of the first macrodiol (A) and the second macrodiol (B) is 30 mol % or more and 55 mol % or less.

The present invention [5] includes the polyurethane resin described in the above-described [4], wherein a ratio of the second macrodiol (B) with respect to a total mol of the polyisocyanate component, the first macrodiol (A), the second macrodiol (B), and the chain extender (C) is 5.5 mol % or more and 10.5 mol % or less.

The present invention [6] includes the polyurethane resin described in the above-described [4] or [5], wherein the prepolymer composition and/or the chain extending component contain(s) acetylacetone.

The present invention [7] includes an elastic molded article including: the polyurethane resin described in any one of the above-described [4] to [6].

The present invention [8] includes a method of producing a prepolymer composition containing an isocyanate group-terminated prepolymer, the method including: a step of allowing a polyisocyanate component including 1,4-bis(isocyanatomethyl) cyclohexane to react with a polyol component including a first macrodiol (A) and a second macrodiol (B), wherein the first macrodiol (A) has a hydroxyl group value of more than 56.1 mgKOH/g and less than 172 mgKOH/g, wherein the second macrodiol (B) has a hydroxyl group value of 374 mgKOH/g or more and 561 mgKOH/g or less, and wherein a ratio of the second macrodiol (B) with respect to a total mol of the first macrodiol (A) and the second macrodiol (B) is 30 mol % or more and 55 mol % or less.

### Effects of the Invention

In the present invention, the polyol component includes a first macrodiol (A) and a second macrodiol (B). Then, the hydroxyl group value of the first macrodiol (A) and the hydroxyl group value of the second macrodiol (B) are in predetermined ranges. According to the prepolymer composition, a polyurethane resin having excellent mechanical properties (high hardness) can be produced. Furthermore, an internal defect of the polyurethane resin can be suppressed.

The polyurethane resin and elastic molded article of the present invention have excellent mechanical properties (high hardness), and can suppress an internal defect.

According to the method of producing the prepolymer composition of the present invention, the above-described prepolymer composition can be produced.

### DESCRIPTION OF THE EMBODIMENTS

A polyurethane resin contains a reaction product of a prepolymer composition (a first component) and a chain extending component (a second component). The prepolymer composition (the first component) and the chain extending component (the second component) are, for example, prepared as a resin kit and are mixed together to cause a urethane-forming reaction.

The polyurethane resin preferably consists of a reaction product of the prepolymer composition (the first component) and the chain extending component (the second component). That is to say, the polyurethane resin is preferably a cured urethane product produced by the reaction of the prepolymer composition with the chain extending component, and the curing of them.

The prepolymer composition (the first component) contains an isocyanate group-terminated prepolymer as an essential component.

The isocyanate group-terminated prepolymer includes a reaction product of a polyisocyanate component and a polyol component. Preferably, the isocyanate group-terminated prepolymer consists of a reaction product of a polyisocyanate component and a polyol component.

The polyisocyanate component includes 1,4-bis(isocyanatomethyl) cyclohexane as an essential component. The 1,4-bis(isocyanatomethyl) cyclohexane has a cis-1,4-bis (isocyanatomethyl) cyclohexane and a trans-1,4-bis (isocyanatomethyl) cyclohexane as a stereoisomer. Hereinafter, the cis-1,4-bis (isocyanatomethyl) cyclohexane may be referred to as a cis-1,4 isomer. Furthermore, the trans-1,4-bis (isocyanatomethyl) cyclohexane may be referred to as a trans-1,4 isomer. The total amount of the trans-1,4 isomer and the cis-1,4 isomer is 100 mol %.

In the 1,4-bis(isocyanatomethyl) cyclohexane, the content ratio of the trans-1,4 isomer is, for example, 60 mol % or more, preferably 70 mol % or more, more preferably 80 mol % or more, even more preferably 85 mol % or more. Furthermore, in the 1,4-bis(isocyanatomethyl) cyclohexane, the content ratio of the trans-1,4 isomer is, for example, 100 mol % or less, preferably 99.8 mol % or less, more preferably 99 mol % or less, even more preferably 96 mol % or less, even more preferably 90 mol % or less.

Furthermore, in the 1,4-bis(isocyanatomethyl) cyclohexane, the content ratio of the cis-1,4 isomer is, for example, 0 mol % or more, preferably 0.2 mol % or more, more preferably 1 mol % or more, even more preferably 4 mol % or more, even more preferably 10 mol % or more. Furthermore, in the 1,4-bis(isocyanatomethyl) cyclohexane, the content ratio of the cis-1,4 isomer is, for example, 40 mol % or less, preferably 30 mol % or less, more preferably 20 mol % or less, even more preferably 15 mol % or less.

The content ratio of the trans-1,4 isomer and the content ratio of the cis-1,4 isomer are in the above-described ranges, a polyurethane resin having excellent mechanical strength can be produced.

Furthermore, the 1,4-bis(isocyanatomethyl) cyclohexane may be a modified product in a range that does not reduce the excellent effects of the present invention. Examples of the modified product include a urethodione modified product, an isocyanurate modified product, iminooxadiazinedione, a biuret modified product, an allophanate modified product, a polyol adduct, an oxadiazinetrione modified product, and a carbodiimide modified product. The polyisocyanate component can include an isocyanate (hereinafter, another polyisocyanate) except for 1,4-bis(isocyanatomethyl) cyclohexane as an optional component in a range that does not reduce the excellent effects of the present invention. Examples of the other polyisocyanate include diisocyanate.

More specifically, examples of the other polyisocyanate include aliphatic polyisocyanate, alicyclic polyisocyanate (except for 1,4-bis(isocyanatomethyl) cyclohexane), aromatic polyisocyanate, and araliphatic polyisocyanate. Examples of the aliphatic polyisocyanate include trimethylene diisocyanate, tetramethylene diisocyanate, pentamethylene diisocyanate (PDI), hexamethylene diisocyanate (HDI), 1,2-propane diisocyanate, 1,2-butane diisocyanate, 2,3-butane diisocyanate, 1,3-butane diisocyanate, 2,4,4-trimethyl hexamethylene diisocyanate, 2,2,4-trimethyl hexamethylene diisocyanate, and 2,6-diisocyanate methylcaproate. Examples of the alicyclic polyisocyanate include 1,3-bis(isocyanatomethyl) cyclohexane (1,3-H6XDI), isophorone diisocyanate (IPDI), norbornene diisocyanate (NBDI), and methylene bis (cyclohexyl isocyanate) (H12MDI). Examples of the aromatic polyisocyanate include tolylene diisocyanate (TDI), diphenylmethane diisocyanate (MDI), toluidine diisocyanate (TODI), paraphenylene diisocyanate, and naphthalene diisocyanate (NDI). Examples of the araliphatic polyisocyanate include xylylene diisocyanate (XDI) and tetramethyl xylylene diisocyanate (TMXDI). Alternatively, the other polyisocyanate may be the above-described modified product in a range that does not reduce the excellent effects of the present invention. These can be used alone or in combination of two or more.

The content ratio of the other polyisocyanate to the total amount of the polyisocyanate component is, for example, 50% by mass or less, preferably 30% by mass or less, more preferably 10% by mass or less, particularly preferably 0% by mass. Furthermore, the content ratio of 1,4-bis(isocyanatomethyl) cyclohexane to the total amount of the polyisocyanate component is, for example, 50% by mass or more, preferably 70% by mass or more, more preferably 90% by mass or more, particularly preferably 100% by mass. That is to say, the polyisocyanate component particularly preferably consists of 1,4-bis(isocyanatomethyl) cyclohexane.

The polyol component includes a first macrodiol (A) and a second macrodiol (B). The macrodiol is an organic compound having two hydroxyl groups in its molecule and having a relatively high molecular weight. A relatively high molecular weight indicates that the number average molecular weight is 200 or more.

Examples of the first macrodiol (A) include a polyether diol, a polyester diol, a polycarbonate diol, a polyurethane diol, an epoxy diol, a vegetable oil diol, a polyolefin diol, an acrylic diol, and a vinyl monomer-modified diol. As the first macrodiol (A), preferably, a polyether diol, a polyester diol, and a polycarbonate diol are used.

Examples of the polyether diol include a polyoxyalkylene diol. Examples of the polyoxyalkylene diol include a polyoxyalkylene (C2-3) diol, and a polytetramethylene ether diol.

Examples of the polyester diol include a condensed polyester diol and a ring-opening polyester diol. Examples of the condensed polyester diol include an adipate-based polyester diol (for example, polybutylene adipate) and a phthalate-based polyester diol. Examples of the ring-opening polyester diol include a lactone-based polyester diol, more specifically include a polycaproctone diol.

Examples of the polycarbonate diol include a ring-opening polymer of ethylene carbonate using dihydric alcohols described below as an initiator.

These first macrodiols (A) can be used alone or in combination of two or more. In view of the improvement of the mechanical properties and the suppression of an internal defect, as the first macrodiol (A), a polyether diol is preferably used, and a polytetramethylene ether diol is more preferably used.

Examples of the second macrodiol (B) include the above-described polyether diol, the above-described polyester diol, the above-described polycarbonate diol, the above-described polyurethane diol, the above-described epoxy diol, the above-described vegetable oil diol, the above-described polyolefin diol, the above-described acrylic diol, and the above-described vinyl monomer-modified diol.

These second macrodiols (B) can be used alone or in combination of two or more. In view of the improvement of the mechanical properties and the suppression of an internal defect, as the second macrodiol (B), a polyether diol is preferably used. A polytetramethylene ether diol is more preferably used. Furthermore, in view of the compatibility, as the second macrodiol (B), preferably, the same types of diols as the first macrodiol (A) are used.

In the polyol component, the first macrodiol (A) and the second macrodiol (B) are distinguished from each other by hydroxyl group value. That is to say, the hydroxyl group value of the first macrodiol (A) is smaller than the hydroxyl group value of the second macrodiol (B).

More specifically, in view of the mechanical properties, the hydroxyl group value of the first macrodiol (A) is more than 56.1 mgKOH/g, preferably 60 mgKOH/g or more, more preferably 75 mgKOH/g or more, even more preferably 85 mgKOH/g or more. Furthermore, in view of the mechanical properties, the hydroxyl group value of the first macrodiol (A) is, for example, less than 172 mgKOH/g, preferably 160 mgKOH/g or less, more preferably 150 mgKOH/g or less, even more preferably 140 mgKOH/g or less.

Furthermore, in view of the suppression of an internal defect, the hydroxyl group value of the second macrodiol (B) is 374 mgKOH/g or more, preferably 400 mgKOH/g or more, more preferably 416 mgKOH/g or more, even more preferably 430 mgKOH/g or more. Furthermore, in view of the mechanical properties, the hydroxyl group value of the second macrodiol (B) is 561 mgKOH/g or less, preferably 510 mgKOH/g or less, more preferably 488 mgKOH/g or less, even more preferably 468 mgKOH/g or less.

Furthermore, the difference between the hydroxyl group value of the first macrodiol (A) and the hydroxyl group value of the second macrodiol (B) is, for example, 202 mgKOH/g or more, preferably 250 mgKOH/g or more, more preferably 300 mgKOH/g or more. Furthermore, the difference between the hydroxyl group value of the first macrodiol (A) and the hydroxyl group value of the second macrodiol (B) is, for example, 504.9 mgKOH/g or less, preferably 450 mgKOH/g or less, more preferably 400 mgKOH/g or less.

The hydroxyl group value can be measured, for example, by a known method of measuring a hydroxyl group value. Examples of the method of measuring a hydroxyl group value include an acetylation method and a phthalated method. Furthermore, the hydroxyl group value can also be calculated from the material ratio of the first macrodiol (A) to the second macrodiol (B).

Furthermore, the hydroxyl group value can also be calculated, for example, according to the following formula (1).

$$( 1 )$$

$$Hydroxyl Group Value = 56100 \times Average Number of Hydroxyl Groups / Number Average Molecular Weight$$

In the above-described formula (1), the number average molecular weight of the first macrodiol (A) and the number average molecular weight of the second macrodiol (B) are measured as a molecular weight in terms of standard polystyrene, for example, by a known gel permeation chromatography (GPC) (hereinafter the same applies).

Furthermore, in the above-described formula (1), the average number of hydroxyl groups of the first macrodiol (A) is 2. Furthermore, the average number of hydroxyl groups of the second macrodiol (B) is 2.

Therefore, the first macrodiol (A) and the second macrodiol (B) can be distinguished by number average molecular weight. That is to say, the number average molecular weight of the first macrodiol (A) is larger than the number average molecular weight of the second macrodiol (B).

More specifically, the number average molecular weight of the first macrodiol (A) is, for example, more than 650, preferably 700 or more, more preferably 750 or more, even more preferably 800 or more. Furthermore, the number average molecular weight of the first macrodiol (A) is, for example, less than 2000, preferably 1870 or less, more preferably 1500 or less, even more preferably 1300 or less.

Furthermore, the number average molecular weight of the second macrodiol (B) is 200 or more, preferably 220 or more, more preferably 230 or more, even more preferably 240 or more. Furthermore, the number average molecular weight of the second macrodiol (B) is 300 or less, preferably 280 or less, more preferably 270 or less, even more preferably 260 or less. By using the first macrodiol (A) and second macrodiol (B) described above in combination, a contraction of the polyurethane resin is suppressed and the occurrence of an internal defect is suppressed.

In the polyol component, the ratio of the first macrodiol (A) to the second macrodiol (B) used in combination is adjusted in view of keeping the balance between the mechanical properties and the suppression of an internal defect.

More specifically, in view of the mechanical properties, the first macrodiol (A) with respect to the total mol of the first macrodiol (A) and the second macrodiol (B) is 45 mol % or more, preferably 50 mol % or more, more preferably 55 mol % or more, even more preferably 60 mol % or more. Furthermore, in view of the suppression of an internal defect, the first macrodiol (A) is 70 mol % or less, preferably 68 mol % or less, more preferably 66 mol % or less.

Furthermore, in view of the suppression of an internal defect, the second macrodiol (B) with respect to the total mol of the first macrodiol (A) and the second macrodiol (B) is 30 mol % or more, preferably 32 mol % or more, more preferably 34 mol % or more. Furthermore, in view of the mechanical properties, the second macrodiol (B) is 55 mol % or less, preferably 50 mol % or less, more preferably 45 mol % or less, even more preferably 40 mol % or less.

The polyol component can contain a macropolyol having an average number of hydroxyl groups of 3 or more in a range that does not reduce the excellent effects of the present invention. Preferably, the polyol component does not contain a macropolyol having an average number of hydroxyl groups of 3 or more. Furthermore, the polyol component can contain a low molecular-weight polyol described below in a range that does not reduce the excellent effects of the present invention. Preferably, the polyol component does not contain the low molecular-weight polyol described below. The total of the content ratio of the above-described first macropolyol (A) and the content ratio of the above-described second macropolyol (B) with respect to the polyol component is, for example, 90% by mass or more, preferably 95% by mass or more, particularly preferably 100% by mass. That is to say, the polyol component particularly preferably consists of the above-described first macropolyol (A) and the above-described second macropolyol (B).

The prepolymer composition is, for example, a reaction mixture of the above-described polyisocyanate component and the above-described polyol component.

More specifically, the prepolymer composition is produced by a method of producing a prepolymer composition below. That is to say, for example, the above-described polyisocyanate component is reacted with the above-described polyol component in a predetermined ratio, thereby preparing a reaction mixture including an isocyanate group-terminated prepolymer (prepolymer synthesis step).

In the prepolymer synthesis step, the equivalent ratio R (NCO/OH) of the isocyanate group in the polyisocyanate component to the hydroxyl group in the polyol component is, for example, more than 1.0, preferably 1.5 or more, more preferably 2.0 or more, even more preferably 2.5 or more. Furthermore, the equivalent ratio R (NCO/OH) of the isocyanate group in the polyisocyanate component to the hydroxyl group in the polyol component is, for example, 20 or less, preferably 10 or less, more preferably 5 or less.

In view of the improvement of the mechanical properties and the suppression of an internal defect, the ratio of the polyisocyanate component with respect to the total mol of the polyisocyanate component, the first macrodiol (A), and the second macrodiol (B) is, for example, 60 mol % or more, preferably 70 mol % or more, more preferably 72 mol % or more, even more preferably 73 mol % or more. Furthermore, the ratio of the polyisocyanate component is, for example, 95 mol % or less, preferably 90 mol % or less, more preferably 80 mol % or less, even more preferably 74 mol % or less.

Furthermore, in view of the improvement of the mechanical properties and the suppression of an internal defect, the ratio of the first macrodiol (A) with respect to the total mol of the polyisocyanate component, the first macrodiol (A), and the second macrodiol (B) is, for example, 2 mol % or more, preferably 10 mol % or more, more preferably 14 mol % or more, even more preferably 15 mol % or more. Furthermore, the ratio of the first macropolyol (A) is, for example, 25 mol % or less, preferably 20 mol % or less, more preferably 18 mol % or less, even more preferably 17 mol % or less.

Furthermore, in view of the improvement of the mechanical properties and the suppression of an internal defect, the ratio of the second macrodiol (B) with respect to the total mol of the polyisocyanate component, the first macrodiol (A), and the second macrodiol (B) is, for example, 5 mol % or more, preferably 7 mol % or more, more preferably 8 mol % or more, even more preferably 9 mol % or more. Furthermore, the ratio of the second macrodiol (B) is, for example, 20 mol % or less, preferably 15 mol % or less, more preferably 13 mol % or less, even more preferably 10 mol % or less.

In the prepolymer synthesis step, examples of the reaction method include bulk polymerization and solution polymerization. In bulk polymerization, for example, the polyisocyanate component and the polyol component are reacted under a nitrogen gas stream. The reaction temperature is, for example, 50° C. or more. Furthermore, the reaction temperature is, for example, 250° C. or less, preferably 200° C. or less. Furthermore, the reaction time is, for example, 0.5 hours or more, preferably 1 hour or more. Furthermore, the reaction time is, for example, 15 hours or less. In solution polymerization, the polyisocyanate component and the polyol component are reacted in the presence of a known organic solvent. The reaction temperature is, for example, 50° C. or more. Furthermore, the reaction temperature is, for example, 120° C. or less, preferably 100° C. or less. Furthermore, the reaction time is, for example, 0.5 hours or more, preferably 1 hour or more. Furthermore, the reaction time is, for example, 15 hours or less.

In this manner, a reaction mixture including the isocyanate group-terminated prepolymer is produced. The reaction mixture is a prepolymer composition.

Furthermore, in the prepolymer synthesis step, as necessary, the reaction mixture is purified, and thus the isocyanate group concentration of the prepolymer composition can be adjusted. Examples of the purification method include distillation and extraction.

Furthermore, in the prepolymer synthesis step, as necessary, an isocyanate monomer is added to the reaction mixture, and thus the isocyanate group concentration of the prepolymer composition can be adjusted.

That is to say, the prepolymer composition can contain an isocyanate monomer as an optional component in addition to the isocyanate group-terminated prepolymer. Examples of the isocyanate monomer include the above-described 1,4-bis(isocyanatomethyl) cyclohexane, and the other polyisocyanate (isocyanate except for 1,4-bis(isocyanatomethyl) cyclohexane) described above. These can be used alone or in combination of two or more.

The isocyanate monomer may intentionally be added to the prepolymer composition. Furthermore, the isocyanate monomer may be contained as unavoidable impurities (unreacted monomer) in the prepolymer composition. In the prepolymer composition, the content ratio of the isocyanate monomer is appropriately adjusted depending on the purpose and use.

The isocyanate group concentration of the prepolymer composition is, for example, 3.0% by mass or more, preferably 5.0% by mass or more. Furthermore, the isocyanate group concentration of the prepolymer composition is, for example, 20.0% by mass or less, preferably 15.0% by mass or less, more preferably 12.0% by mass or less. The isocyanate group concentration can be obtained by a known measurement method. Examples of the measurement method include titrimetry using di-n-butylamine and FT-IR analysis (hereinafter the same applies).

In the prepolymer composition described above, the polyol component includes the first macrodiol (A) and the second macrodiol (B). Then, the hydroxyl group value of the first macrodiol (A) and the hydroxyl group value of the second macrodiol (B) are in predetermined ranges. According to the prepolymer composition described above, a polyurethane resin having excellent mechanical properties (high hardness) can be produced. Furthermore, an internal defect of the polyurethane resin can be suppressed. Furthermore, according to the above-described prepolymer composition, the exothermic property of the polyurethane resin can be reduced.

As described above, the polyurethane resin consists of a reaction product of the prepolymer composition (the first component) and the chain extending component (the second component).

The chain extending component (the second component) contains, for example, a chain extender (C) (a chain extending compound).

The chain extender (C) is a curing agent for the prepolymer composition. Examples of the chain extender (C) include a low molecular-weight polyol and a low molecular weight polyamine. As the chain extender (C), preferably, a low molecular-weight polyol is used. By using a low molecular-weight polyol, a polyurethane resin having excellent mechanical strength can be produced.

Examples of the low molecular-weight polyol include the above-described low molecular-weight polyols. More specifically, examples of the low molecular-weight polyol include the above-described dihydric alcohols, the above-described trihydric alcohols, and the above-described tetrahydric or more alcohols. These can be used alone or in combination of two or more.

Examples of the low molecular-weight polyol include a dihydric alcohol, a trihydric alcohol, and a tetrahydric or more alcohol. Examples of the dihydric alcohol include an ethylene glycol, a 1,2-propanediol, a 1,3-propanediol, a 1,2-butanediol, a 1,3-butanediol, a 1, 4-butanediol, a 1,5-pentanediol, a 1,6-hexanediol, a neopentyl glycol, a diethylene glycol, a triethylene glycol, and a dipropylene glycol. Examples of the trihydric alcohol include glycerin and trimethylolpropane. Examples of the tetrahydric or more alcohol include pentaerythritol and diglycerin. Furthermore, examples of the low molecular-weight polyol also include a polymer produced by the additional polymerization of alkylene (C2˜3) oxide to a dihydric to tetrahydric alcohol so that the number average molecular weight becomes 400 or less. These can be used alone or in combination of two or more.

As the low molecular-weight polyol, dihydric alcohols and trihydric alcohols are preferably used, dihydric alcohols are more preferably used, 1,4-butanediol is even more preferably used. That is to say, the low molecular-weight polyol preferably contains 1, 4-butanediol, more preferably consists of 1, 4-butanediol. In this manner, a polyurethane resin having excellent mechanical strength can be produced.

The polyurethane resin is produced, for example, by the method below. That is to say, for example, the above-described prepolymer composition is reacted with the above-described chain extending component to cause the chain extension of the isocyanate group-terminated prepolymer (chain extending step).

In the chain extending step, the equivalent ratio R (NCO/OH) of the isocyanate group in the prepolymer composition with respect to the hydroxyl group in the chain extending component (the chain extender (C)) is, for example, 0.90 or more, preferably 1.00 or more. Furthermore, the equivalent ratio R (NCO/OH) of the isocyanate group in the prepolymer composition with respect to the hydroxyl group in the chain extending component (the chain extender (C)) is, for example, 1.33 or less, preferably 1.25 or less.

In view of the improvement of the mechanical properties and the suppression of an internal defect, the ratio of the polyisocyanate component with respect to the total mol of the polyisocyanate component, the first macrodiol (A), the second macrodiol (B), and the chain extender (C) is, for example, 40.0 mol % or more, preferably 47.0 mol % or more, more preferably 49.0 mol % or more, even more preferably 50.0 mol % or more. Furthermore, the ratio of the polyisocyanate component is, for example, 60.0 mol % or less, preferably 55.0 mol % or less, more preferably 52.0 mol % or less, even more preferably 51.0 mol % or less.

Furthermore, in view of the improvement of the mechanical properties and the suppression of an internal defect, the ratio of the first macrodiol (A) with respect to the total mol of the polyisocyanate component, the first macrodiol (A), the second macrodiol (B), and the chain extender (C) is, for example, 6.0 mol % or more, preferably 8.0 mol % or more, more preferably 10.0 mol % or more, even more preferably 11.0 mol % or more. Furthermore, the ratio of the first macropolyol (A) is, for example, 20.0 mol % or less, preferably 18.0 mol % or less, more preferably 15.0 mol % or less, even more preferably 13.0 mol % or less.

Furthermore, in view of the improvement of the mechanical properties and the suppression of an internal defect, the ratio of the second macrodiol (B) with respect to the total mol of the polyisocyanate component, the first macrodiol (A), the second macrodiol (B), and the chain extender (C) is, for example, 2.0 mol % or more, preferably 4.0 mol % or more, more preferably 5.5 mol % or more, even more preferably 6.0 mol % or more. Furthermore, the ratio of the second macrodiol (B) is, for example, 15.0 mol % or less, preferably 12.0 mol % or less, more preferably 10.5 mol % or less, even more preferably 9.0 mol % or less.

Furthermore, in view of the improvement of the mechanical properties and the suppression of an internal defect, the ratio of the chain extender (C) with respect to the total mol of the polyisocyanate component, the first macrodiol (A), the second macrodiol (B), and the chain extender (C) is, for example, 20.0 mol % or more, preferably 23.0 mol % or more, more preferably 25.0 mol % or more, even more preferably 28.0 mol % or more. Furthermore, the ratio of the chain extender (C) is, for example, 50.0 mol % or less, preferably 45.0 mol % or less, more preferably 40.0 mol % or less, even more preferably 35.0 mol % or less.

In the chain extending step, examples of the reaction method include the above-described bulk polymerization and the above-described solution polymerization. In bulk polymerization, the reaction temperature is, for example, 50° C. or more, preferably 100° C. or more. Furthermore, the reaction temperature is, for example, 250° C. or less, preferably 200° C. or less, more preferably 180° C. or less, even more preferably 150° C. or less. Furthermore, the reaction time is, for example, 0.5 hours or more, preferably 1 hour or more. Furthermore, the reaction time is, for example, 24 hours or less, preferably 20 hours or less, more preferably 18 hours or less. In solution polymerization, the reaction temperature is, for example, 50° C. or more. Furthermore, the reaction temperature is, for example, 120° C. or less, preferably 150° C. or less. Furthermore, the reaction time is, for example, 0.5 hour or more, preferably 1 hour or more. Furthermore, the reaction time is, for example, 24 hours or less.

In this manner, a polyurethane resin including a reaction product of the prepolymer composition and the chain extending component is produced. Preferably, as necessary, the mixture of the prepolymer composition and the chain extending component is defoamed and cured in a mold preliminarily heated, and demolded. In this manner, a polyurethane resin molded into a desired shape is produced.

Furthermore, the prepolymer composition and the chain extending component can contain an additive as an optional component. Examples of the additive include a urethane-forming catalyst (for example, an organometallic catalyst), a catalytic activity adjusting agent, an antioxidant, a heat-resistant stabilizer, a light-resistant stabilizer, an ultraviolet absorber, an antiblocking agent, a mold release agent, a pigment, a dye, a lubricant, a filler, a hydrolysis inhibitor, an antirust agent, and a bluing agent. The added amount of the additive and the timing of the addition are appropriately set depending on the purpose and use.

In view of adjusting the rate of the urethane-forming reaction in the chain extending step to suppress an internal defect of the polyurethane resin, the prepolymer composition and/or the chain extending component preferably contain a catalytic activity adjusting agent.

Examples of the catalytic activity adjusting agent include acetylacetone and ethyl acetoacetate. These can be used alone or in combination of two or more. As the catalytic activity adjusting agent, preferably, acetylacetone is used. In other words, the prepolymer composition and/or the chain extending component preferably contain acetylacetone. More preferably, the prepolymer composition contains a catalytic activity adjusting agent. The content ratio of the catalytic activity adjusting agent is appropriately adjusted, for example, depending on the conditions for the urethane-forming reaction and the blending amount of the urethane-forming catalyst (for example, the organometallic catalyst).

As necessary, the polyurethane resin may be subjected to a heat treatment. The heat treatment temperature is, for example, 50° C. or more, preferably 80° C. or more. Furthermore, the heat treatment temperature is, for example, 200° C. or less, preferably 150° C. or less. Furthermore, the heat treatment time is, for example, 30 minutes or more, preferably 1 hour or more. Furthermore, the heat treatment time is, for example, 30 hours or less, preferably 20 hours or less. Furthermore, the polyurethane resin may be aged. The aging temperature is, for example, 10° C. or more, preferably 20° C. or more. Furthermore, the aging temperature is, for example, 50° C. or less, preferably 40° C. or less. Furthermore, the aging time is, for example, 1 hour or more, preferably 10 hours or more. Furthermore, the aging time is, for example, 50 days or less, preferably 30 days or less.

As necessary, the polyurethane resin can include a known additive. That is to say, the polyurethane resin may be a polyurethane resin composition. Examples of the additive include a urethane-forming catalyst, a catalytic activity adjusting agent, an antioxidant, a heat-resistant stabilizer, a light-resistant stabilizer, an ultraviolet absorber, an antiblocking agent, a mold release agent, a pigment, a dye, a lubricant, a filler, a hydrolysis inhibitor, an antirust agent, and a bluing agent. The added amount of the additive and the timing of the addition are appropriately set depending on the purpose and use.

Then, the above-described polyurethane resin has excellent mechanical properties (high hardness) and can suppress an internal defect.

That is to say, in the above-described polyurethane resin, the polyol component includes the first macrodiol (A) and the second macrodiol (B). Then, the hydroxyl group value of the first macrodiol (A) and the hydroxyl group value of the second macrodiol (B) are in predetermined ranges. According to the prepolymer composition described above, a polyurethane resin having excellent mechanical properties (high hardness) can be produced. Furthermore, an internal defect of the polyurethane resin can be suppressed.

Therefore, the above-described polyurethane resin has excellent mechanical properties (high hardness) and can suppress an internal defect. Furthermore, the above-described polyurethane resin has an excellent low exothermic property.

As a result, the above-described polyurethane resin and prepolymer composition are preferably used in various industrial fields requiring mechanical properties (high hardness) and the suppression of an internal defect. Examples of the industrial fields include elastic molded articles, paints, coating agents, and adhesives. Preferably, the above-described polyurethane resin and prepolymer composition are used in the field of elastic molded articles.

Examples of the elastic molded articles include a polyurethane elastomer. Examples of the polyurethane elastomer include TPU (thermoplastic polyurethane resin) and TSU (thermosetting polyurethane resin). The elastic molded article is preferably TSU (thermosetting polyurethane resin).

The elastic molded article is produced by molding the polyurethane resin by a known molding method. Examples of the molding method include cast molding, thermal compression molding, injection molding, extrusion molding, and spinning molding. Furthermore, examples of the shape after the molding include a board shape, a fiber shape, a strand shape, a film shape, a sheet shape, a pipe shape, a bolt shape, a hollow shape, a box shape, and a button shape.

The elastic molded article is preferably produced by cast molding. Therefore, the elastic molded article is preferably a cast molded polyurethane elastomer. The cast molded polyurethane elastomer is a molded article produced by cast molding (cast molded product), and a product solely having a predetermined shape depending on the purpose and use, and distinguished from a coating agent applied to an object to be coated.

The elastic molded article described above includes the above-described polyurethane resin, and thus has excellent mechanical strength and can suppress the catch of air bubbles. Therefore, the elastic molded article is preferably used for various uses. Examples of the uses of the elastic molded article include, for example, transparent rigid plastics, waterproof materials, potting agents, inks, binders, films, sheets, bands, belts, shoe press belts, tubes, blades, loudspeakers, sensors, outsoles, threads, fibers, non-woven fabrics, cosmetic products, items of shoes, heat insulators, seal materials, tape materials, sealing materials, photovoltaic components, robot components, android components, wearable components, items of clothing, hygiene products, cosmetic items, furniture products, components for food-packaging, sports items, leisure items, medical products, nursing care products, house components, audio components, lighting components, vibration-proof components, acoustic insulation components, daily use items, sundry items, cushion, bedclothes, stress absorbers, stress relaxation materials, car interior materials, car exterior materials, components for railway, aircraft components, optical elements, components for office automation equipment, sundry item-surface protection materials, sealing materials for semiconductors, self-repairing materials, health appliances, lenses for eyeglasses, toys, packings, cable sheaths, wire harnesses, electrical communication cables, wiring for vehicles, computer wiring, industry products, shock absorbers, semiconductor products, and bridge bearings.

### EXAMPLES

Next, the present invention is described based on Examples and Comparative Examples. The present invention is, however, not limited to them. The “parts” and “%” are based on mass unless otherwise specified. The specific numeral values used in the description below, such as mixing ratios (content ratios), physical property values, and parameters, can be replaced with the corresponding mixing ratios (content ratios), physical property values, and parameters in the above-described “DESCRIPTION OF THE EMBODIMENTS”, including the upper limit values (numeral values defined with “or less”, and “less than”) or the lower limit values (numeral values defined with “or more”, and “more than”).

### 1. Raw Material

### <Polyisocyanate Component>

### Production Example 1 1,4-bis(isocyanatomethyl) cyclohexane

In accordance with the description of Production Example 3 of PCT International Publication No. WO2019/069802, 1,4-bis(isocyanatomethyl) cyclohexane (1,4-H6XDI) was produced. The purity of the 1,4-H6XDI was measured by gas chromatography, and the result was 99.9%. Furthermore, the hue measured by APHA measurement was 5. Furthermore, the ratio of the trans-isomer to the cis-isomer measured by 13C-NMR was that the trans-isomer was 86 mol % and the cis-isomer was 14 mol %.

### <Polyol Component>

PTMEG1000: polytetramethylene ether glycol, a number average molecular weight (Mn) 1000
PTMEG650: polytetramethylene ether glycol, a number average molecular weight (Mn) 650
PTMEG500: polytetramethylene ether glycol, a number average molecular weight (Mn) 500
PTMEG300: polytetramethylene ether glycol, a number average molecular weight (Mn) 300
PTMEG250: polytetramethylene ether glycol, a number average molecular weight (Mn) 250
PBA1000: condensed polyester diol (the polybutylene adipate), a number average molecular weight (Mn) 1000
PBA500: condensed polyester diol (the polybutylene adipate), a number average molecular weight (Mn) 500
PBA250: condensed polyester diol (the polybutylene adipate), a number average molecular weight (Mn) 250
PCL1000: polycaproctonediol, a number average molecular weight (Mn) 1000
PCL250: polycaproctonediol, a number average molecular weight (Mn) 250
PC1000: polycarbonate diol, a number average molecular weight (Mn) 1000

### <Chain Extender>

1,4-BD: 1, 4-butanediol
   <Urethane-forming catalyst>
DBTDL: dibutyltin dilaurate, organic tin catalyst

### 2. Prepolymer Composition and Polyurethane Resin

### Examples 1 to 9 and Comparative Examples 1 to 8

### (1) Prepolymer Synthesis Step

According to the formulations and conditions shown in Tables 1 to 4, the polyisocyanate component and the polyol component were reacted under a nitrogen atmosphere. In Tables 1 to 4, the equivalent ratio R of the prepolymer synthesis step indicates the equivalent ratio R (NCO/OH) of the isocyanate group in the polyisocyanate component to the hydroxyl group in the polyol component.

### (2) Chain Extending Step

According to the formulations shown in Tables 1 to 4, the prepolymer composition and the chain extending component were prepared and heated to 60° C. In the presence of the urethane-forming catalyst shown in Tables 1 to 4, the prepolymer composition and the chain extending component were mixed together for 60 seconds and defoamed at reduced pressure at room temperature for 60 seconds. Thereafter, the mixture of the main agent and the curing agent was poured into a mold pre-heated, thereby reacting (curing) the isocyanate group-terminated prepolymer and the chain extender based on the reaction conditions according to Tables 1 to 4, and thereafter demolded. In this manner, the polyurethane resin (a cast molded polyurethane elastomer) was produced.

In the production of the polyurethane resin for evaluating the internal defect, the pre-heating temperature of the mold was 60° C. Furthermore, the molded article had a thickness of 5 cm. Furthermore, in the production of the polyurethane resin for evaluating the other physical properties (hardness and low exothermic property), the pre-heating temperature of the mold was 110° C.

Furthermore, in Example 9, before the prepolymer composition and the chain extending component were mixed together, acetylacetone was added to the prepolymer composition.

### 3. Measurements of Physical Properties

### (1) Isocyanate Group Concentration

The isocyanate group concentration was measured in accordance with the n-dibutylamine method of JIS K 1556 (2006).

### 4. Evaluations

### (1) Internal Defect

The inside of the molded article having a 5 cm cubic shape was observed by X-ray using CT Lab GX130 manufactured by Rigaku Corporation to determine the presence or absence of an internal defect and the size thereof.

The conditions for the X-ray observation are described below.

Tube Voltage: 130 kV, Tube current: 300 uA, FOV: 72 mm, Imaging Mode: High Resolution, Imaging Time: 14 min, Focal Point: L

Furthermore, the evaluation criteria are described below.

Good: An internal defect was not observed.
Fair: An internal defect having a diameter of more than 0 mm and less than 1.0 mm was observed.
Bad: An internal defect having a diameter of 1.0 mm or more was observed.
(2) Mechanical Properties (Hardness) The shore D hardness of the polyurethane resin was measured in accordance with JIS K 7312 (1996).

### (3) Low Exothermic Property (tan δ)

As the index of a low exothermic property, the loss tangent (tan δ) of the polyurethane resin was calculated. More specifically, the dynamic viscoelasticity spectrum of the polyurethane resin was measured using Dynamic Viscoelastic Analyzer (manufactured by IT Sokuryo Seigyo Co., Ltd., Model: DVA-220) under the conditions of a measurement start temperature of −100° C., a rate of temperature increase of 5° C./min, a tensile mode, a length between scale lines of 20 mm, a static/dynamic stress ratio of 1.8, and a measurement frequency of 10 Hz. Thereafter, the loss tangent (tan δ) at 60° C. was calculated.

TABLE 1

| | | | | | | Comp. |
|---|---|---|---|---|---|---|
| | | | Ex. 1 | Ex. 2 | Ex. 3 | Ex. 1 |
| Prepolymer | Polyisocyanate component | Polyisocyanate component | 1,4-H6XDI | 1,4-H6XDI | 1,4-H6XDI | 1,4-H6XDI |
| synthesis | Polyol component | First macrodiol (A) | PTMEG1000 | PTMEG1000 | PTMEG1000 | PTMEG1000 |
| step | | Hydroxyl group value (mgKOH/g) | 112.2 | 112.2 | 112.2 | 112.2 |
| | | Ratio (mol %) | 65 | 65 | 65 | 65 |
| | | Second macrodiol (B) | PTMEG250 | PTMEG200 | PTMEG300 | PTMEG500 |
| | | Hydroxyl group value (mgKOH/g) | 449 | 561 | 374 | 224 |
| | | Ratio (mol %) | 35 | 35 | 35 | 35 |
| | Reaction conditions | Equivalent ratio R (NCO/OH) | 2.8 | 2.8 | 2.9 | 3.0 |
| | | Reaction temperature (° C.) | 80 | 80 | 80 | 80 |
| | | Reaction time (hour) | 3 | 3 | 3 | 3 |
| Prepolymer | Isocyanate group concentration (% by mass) | | 12.0 | 12.0 | 12.0 | 12.0 |
| composition | | | | | | |
| Polyisocyanate component/First macrodiol (A)/Second macrodiol (B) | | | 74/17/9 | 74/17/9 | 74/17/9 | 75/16/9 |
| Molar ratio | | | | | | |
| Chain | Chain extending component | Chain extender (C) | 1,4-BD | 1,4-BD | 1,4-BD | 1,4-BD |
| extending | | Hydroxyl group value (mgKOH/g) | 1240 | 1240 | 1240 | 1240 |
| step | | Equivalent ratio R (NCO/OH) | 1.05 | 1.05 | 1.05 | 1.05 |
| | Urethane-forming catalyst | Type | DBTDL | DBTDL | DBTDL | DBTDL |
| | Amount of catalyst (ppm) | Amount (ppm) | 75 | 75 | 75 | 75 |
| | Acetylacetone | Amount (phr) | — | — | — | — |
| | Reaction conditions | Temperature (° C.) | 110 | 110 | 110 | 110 |
| | | Time (hour) | 16 | 16 | 16 | 16 |

| Polyisocyanate component/First macrodiol (A)/Second macrodiol (B)/ | | 51/12/6/31 | 51/12/6/31 | 51/12/6/31 | 52/11/6/31 |
|---|---|---|---|---|---|
| Chain extender (C) Molar ratio | | | | | |
| Evaluations | Internal defect | Good | Good | Fair | Bad |
| | Mechanical properties | 52 | 53 | 51 | 49 |
| | low exothermic property (tan δ [60° C.]) | 0.04 | 0.05 | 0.04 | 0.04 |

TABLE 2

| | | | Comp. | | | Comp. | Comp. |
|---|---|---|---|---|---|---|---|
| | | | Ex. 2 | Ex. 4 | Ex. 5 | Ex. 3 | Ex. 4 |
| Prepolymer | Polyisocyanate | Polyisocyanate component | 1,4-H6XDI | 1,4-H6XDI | 1,4-H6XDI | 1,4-H6XDI | 1,4-H6XDI |
| synthesis | component | | | | | | |
| step | Polyol component | First macrodiol (A) | PTMEG1000 | PTMEG1000 | PTMEG1000 | PTMEG1000 | PTMEG1000 |
| | | Hydroxyl group value (mgKOH/g) | 112.2 | 112.2 | 112.2 | 112.2 | 112.2 |
| | | Ratio (mol %) | 41 | 50 | 70 | 72 | 100 |
| | | Second macrodiol (B) | PTMEG250 | PTMEG250 | PTMEG250 | PTMEG250 | — |
| | | Hydroxyl group value (mgKOH/g) | 449 | 449 | 449 | 449 | — |
| | | Ratio (mol %) | 59 | 50 | 30 | 28 | — |
| | Reaction conditions | Equivalent ratio R (NCO/OH) | 2.5 | 2.6 | 2.9 | 3.0 | 3.4 |
| | | Reaction temperature (° C.) | 12 | 80 | 80 | 80 | 80 |
| | | Reaction time (hour) | 80 | 3 | 3 | 3 | 3 |
| Prepolymer | Isocyanate group concentration | | 3.0 | 12.0 | 12.0 | 12.0 | 12.0 |
| composition | (% by mass) | | | | | | |
| Polyisocyanate component/First macrodiol | | | 71/12/17 | 72/14/14 | 74/18/8 | 75/18/7 | 77/23/— |
| (A)/Second macrodiol (B) Molar ratio | | | | | | | |
| Chain | Chain extending | Chain extender (C) | 1,4-BD | 1,4-BD | 1,4-BD | 1,4-BD | 1,4-BD |
| extending step | component | Hydroxyl group value (mgKOH/g) | 1240 | 1240 | 1240 | 1240 | 1240 |
| | | Equivalent ratio R (NCO/OH) | 1.05 | 1.05 | 1.05 | 1.05 | 1.05 |
| | Urethane-forming | Type | DBTDL | DBTDL | DBTDL | DBTDL | DBTDL |
| | catalyst | | | | | | |
| | Amount of catalyst | Amount (ppm) | 75 | 75 | 75 | 75 | 75 |
| | (ppm) | | | | | | |
| | Acetylacetone | Amount (phr) | — | — | — | — | — |
| | Reaction conditions | Temperature (° C.) | 110 | 110 | 110 | 110 | 110 |
| | | Time (hour) | 16 | 16 | 16 | 16 | 16 |

| Polyisocyanate component/First macrodiol | | 49/8/12/31 | 49/10/10/31 | 51/12/6/31 | 52/12/5/31 | 51/15/—/34 |
|---|---|---|---|---|---|---|
| (A)/Second macrodiol (B)/Chain extender (C) Molar ratio | | | | | | |
| Evaluations | Internal defect | Good | Good | Fair | Bad | Bad |
| | Mechanical properties | 53 | 53 | 52 | 51 | 47 |
| | low exothermic property | 0.08 | 0.05 | 0.03 | 0.03 | 0.03 |
| | (tan δ [60° C.]) | | | | | |

TABLE 3

| | | | Comp. | Comp. | Comp. | Comp. |
|---|---|---|---|---|---|---|
| | | | Ex. 5 | Ex. 6 | Ex. 7 | Ex. 8 |
| Prepolymer | Polyisocyanate | Polyisocyanate component | 1,4-H6XDI | 1,4-H6XDI | 1,4-H6XDI | 1,4-H6XDI |
| synthesis | component | | | | | |
| step | Polyol component | First macrodiol (A) | PTMEG500 | PTMEG2000 | PTMEG650 | PBA1000 |
| | | Hydroxyl group value (mgKOH/g) | 224 | 56.1 | 160 | 112.2 |
| | | Ratio (mol %) | 65 | 65 | 100 | 60 |
| | | Second macrodiol (B) | PTMEG250 | PTMEG250 | — | PBA500 |
| | | Hydroxyl group value (mgKOH/g) | 449 | 449 | — | 224 |
| | | Ratio (mol %) | 35 | 35 | — | 40 |
| | Reaction conditions | Equivalent ratio R (NCO/OH) | 2.2 | 4.1 | 2.7 | 3.0 |
| | | Reaction temperature (° C.) | 80 | 80 | 80 | 80 |
| | | Reaction time (hour) | 3 | 3 | 3 | 3 |
| Prepolymer | Isocyanate group concentration | | 12.0 | 12.0 | 12.0 | 12.0 |
| composition | (% by mass) | | | | | |
| Polyisocyanate component/First macrodiol | | | 69/20/11 | 80/13/7 | 73/27/— | 75/15/10 |
| (A)/Second macrodiol (B) Molar ratio | | | | | | |
| Chain | Chain extending | Chain extender (C) | 1,4-BD | 1,4-BD | 1,4-BD | 1,4-BD |
| extending step | component | Hydroxyl group value (mgKOH/g) | 1240 | 1240 | 1240 | 1240 |
| | | Equivalent ratio R (NCO/OH) | 1.05 | 1.05 | 1.05 | 1.05 |
| | Urethane-forming | Type | DBTDL | DBTDL | DBTDL | DBTDL |
| | catalyst | | | | | |
| | Amount of catalyst | Amount (ppm) | 75 | 75 | 75 | 75 |
| | (ppm) | | | | | |
| | Acetylacetone | Amount (phr) | — | — | — | — |
| | Reaction conditions | Temperature (° C.) | 110 | 110 | 110 | 110 |
| | | Time (hour) | 16 | 16 | 16 | 16 |

| Polyisocyanate component/First macrodiol | | 48/14/8/31 | 55/9/5/31 | 50/19/—/31 | 52/10/7/31 |
|---|---|---|---|---|---|
| (A)/Second macrodiol (B)/Chain extender (C) Molar ratio | | | | | |
| Evaluations | Internal defect | Good | Good | Good | Bad |
| | Mechanical properties | 53 | 48 | 53 | 49 |
| | low exothermic property | 0.08 | 0.031 | 0.07 | 0.04 |
| | (tan δ [60° C.]) | | | | |

TABLE 4

| | | | Ex. 6 | Ex. 7 | Ex. 8 | Ex. 9 |
|---|---|---|---|---|---|---|
| Prepolymer | Polyisocyanate | Polyisocyanate component | 1,4-H6XDI | 1,4-H6XDI | 1,4-H6XDI | 1,4-H6XDI |
| synthesis | component | | | | | |
| step | Polyol component | First macrodiol (A) | PBA1000 | PCL1000 | PC1000 | PTMEG1000 |
| | | Hydroxyl group value (mgKOH/g) | 112.2. | 112.2. | 112.2. | 112.2 |
| | | Ratio (mol %) | 65 | 65 | 65 | 65 |
| | | Second macrodiol (B) | PBA250 | PTMEG250 | PCL250 | PTMEG250 |
| | | Hydroxyl group value (mgKOH/g) | 449 | 449 | 449 | 449 |
| | | Ratio (mol %) | 35 | 35 | 35 | 35 |
| | Reaction conditions | Equivalent ratio R (NCO/OH) | 2.8 | 2.8 | 2.8 | 2.8 |
| | | Reaction temperature (° C.) | 80 | 80 | 80 | 80 |
| | | Reaction time (hour) | 3 | 3 | 3 | 3 |
| Prepolymer | Isocyanate group concentration | | 12.0 | 12.0 | 12.0 | 12.0 |
| composition | (% by mass) | | | | | |
| Polyisocyanate component/First macrodiol | | | 74/17/9 | 74/17/9 | 74/17/9 | 74/17/9 |
| (A)/Second macrodiol (B) Molar ratio | | | | | | |
| Chain | Chain extending | Chain extender (C) | 1,4-BD | 1,4-BD | 1,4-BD | 1,4-BD |
| extending step | component | Hydroxyl group value (mgKOH/g) | 1240 | 1240 | 1240 | 1240 |
| | | Equivalent ratio R (NCO/OH) | 1.05 | 1.05 | 1.05 | 1.05 |
| | Urethane-forming | Type | DBTDL | DBTDL | DBTDL | DBTDL |
| | catalyst | | | | | |
| | Amount of catalyst | Amount (ppm) | 75 | 75 | 75 | 75 |
| | (ppm) | | | | | |
| | Acetylacetone | Amount (phr) | — | — | — | 0.05 |
| | Reaction conditions | Temperature (° C.) | 110 | 110 | 110 | 110 |
| | | Time (hour) | 16 | 16 | 16 | 16 |

| Polyisocyanate component/First macrodiol | | 51/12/6/31 | 51/12/6/31 | 51/12/6/31 | 51/12/6/31 |
|---|---|---|---|---|---|
| (A)/Second macrodiol (B)/Chain extender (C) Molar ratio | | | | | |
| Evaluations | Internal defect | Good | Good | Good | Excellent |
| | Mechanical properties | 52 | 51 | 53 | 52 |
| | low exothermic property | 0.04 | 0.04 | 0.04 | 0.04 |
| | (tan δ [60° C.]) | | | | |

While the illustrative embodiments of the present invention are provided in the above description, such is for illustrative purpose only and it is not to be construed as limiting in any manner. Modification and variation of the present invention that will be obvious to those skilled in the art is to be covered by the following claims.

### INDUSTRIAL APPLICABILITY

The prepolymer composition, polyurethane resin, elastic molded article, and method of producing the prepolymer composition of the present invention are preferably used, for example, for transparent rigid plastics, waterproof materials, potting agents, inks, binders, films, sheets, bands, belts, shoe press belts, tubes, blades, loudspeakers, sensors, outsoles, threads, fibers, non-woven fabrics, cosmetic products, items of shoes, heat insulators, seal materials, tape materials, sealing materials, photovoltaic components, robot components, android components, wearable components, items of clothing, hygiene products, cosmetic items, furniture products, components for food-packaging, sports items, leisure items, medical products, nursing care products, house components, audio components, lighting components, vibration-proof components, acoustic insulation components, daily use items, sundry items, cushion, bedclothes, stress absorbers, stress relaxation materials, car interior materials, car exterior materials, components for railway, aircraft components, optical elements, components for office automation equipment, sundry item-surface protection materials, sealing materials for semiconductors, self-repairing materials, health appliances, lenses for eyeglasses, toys, packings, cable sheaths, wire harnesses, electrical communication cables, wiring for vehicles, computer wiring, industry products, shock absorbers, semiconductor products, and bridge bearings.

1. A prepolymer composition comprising: an isocyanate group-terminated prepolymer, wherein the isocyanate group-terminated prepolymer contains a reaction product of a polyisocyanate component including 1,4-bis(isocyanatomethyl) cyclohexane and a polyol component including a first macrodiol (A) and a second macrodiol (B),
wherein the first macrodiol (A) has a hydroxyl group value of more than 56.1 mgKOH/g and less than 172 mgKOH/g,
wherein the second macrodiol (B) has a hydroxyl group value of 374 mgKOH/g or more and 561 mgKOH/g or less, and
wherein a ratio of the second macrodiol (B) with respect to a total mol of the first macrodiol (A) and the second macrodiol (B) is 30 mol % or more and 55 mol % or less.

2. The prepolymer composition according to claim 1,
wherein the ratio of the second macrodiol (B) with respect to a total mol of the polyisocyanate component, the first macrodiol (A), and the second macrodiol (B) is 8 mol % or more and 15 mol % or less.

3. The prepolymer composition according to claim 1, further comprising acetylacetone.

4. A polyurethane resin, comprising:
a reaction product of a prepolymer composition containing an isocyanate group-terminated prepolymer and a chain extending component containing a chain extender (C),
wherein the isocyanate group-terminated prepolymer contains a reaction product of a polyisocyanate component including 1,4-bis(isocyanatomethyl) cyclohexane and a polyol component including a first macrodiol (A) and a second macrodiol (B),
wherein the first macrodiol (A) has a hydroxyl group value of more than 56.1 mgKOH/g and less than 172 mgKOH/g,
wherein the second macrodiol (B) has a hydroxyl group value of 374 mgKOH/g or more and 561 mgKOH/g or less, and
wherein a ratio of the second macrodiol (B) with respect to a total mol of the first macrodiol (A) and the second macrodiol (B) is 30 mol % or more and 55 mol % or less.

5. The polyurethane resin according to claim 4,
wherein a ratio of the second macrodiol (B) with respect to a total mol of the polyisocyanate component, the first macrodiol (A), the second macrodiol (B), and the chain extender (C) is 5.5 mol % or more and 10.5 mol % or less.

6. The polyurethane resin according to claim 4,
wherein the prepolymer composition and/or the chain extending component contain(s) acetylacetone.

7. An elastic molded article comprising: the polyurethane resin according to claim 4.

8. A method of producing a prepolymer composition containing an isocyanate group-terminated prepolymer, the method comprising:
a step of allowing a polyisocyanate component including 1,4-bis(isocyanatomethyl) cyclohexane to react with a polyol component including a first macrodiol (A) and a second macrodiol (B),
wherein the first macrodiol (A) has a hydroxyl group value of more than 56.1 mgKOH/g and less than 172 mgKOH/g,
wherein the second macrodiol (B) has a hydroxyl group value of 374 mgKOH/g or more and 561 mgKOH/g or less, and
wherein a ratio of the second macrodiol (B) with respect to a total mol of the first macrodiol (A) and the second macrodiol (B) is 30 mol % or more and 55 mol % or less.
